(19) United States
(12) Patent Application Publication
(10) Pub. No.: US 2011/0030273 A1
(43) Pub. Date: Feb. 10, 2011

(54) METHOD FOR MAKING A PLANT WALL

(75) Inventor: Daniel Soupe, Chatillon Sur Chalaronne (FR)

Correspondence Address: Andrew W. Chu, PC, P. O. Box 2925, Houston, TX, 77252-2925, US

(73) Assignee: SINNOVEG, Chatillon Sur Chalaronne (FR)

(21) Appl. No.: 12/937,363

(22) PCT Filed: Apr. 16, 2009
(86) PCT No.: PCT/FR2009/050708

§ 371 Date: Oct. 11, 2010

(30) Foreign Application Priority Data
Apr. 16, 2008 (FR) 0852580

(51) Int. Cl. A01G 1/00; A01C 11/04; A01G 1/06

(52) U.S. Cl. 47/58.1 R; 111/100

(57) ABSTRACT

The invention relates to a method for making a plant wall including the steps of: preparing rooted trees having one or more trunks; planting the trees very close to each other; and guiding and maintaining the trees by mechanical mechanisms while they sprout in order to make them fuse together or graft onto each other, side by side, on practically the entire length of the trunks thereof so as to form, along the planting line, a juxtaposition of vertical live trunks fused to each other to form a full wall.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to a method for making a plant wall.

A plant wall obtained according to the method object of the present invention will find a particularly advantageous application in the field of the fight against sound, visual and security nuisance.

2. Description of Related Art Including Information Disclosed Under 37 CFR 1.97 and 37 CFR 1.98.

Noise-barrier walls, namely built on the sides of the roadways in the vicinity of residential sites, are already known. These noise-barrier walls are generally masonry constructions, which generally have, on the side exposed to the noise emissions, an uneven surface capable of reflecting the sound, eventually several times in different directions so as to attenuate it.

These noise-barrier walls are efficient, but have however the drawback of questionable aesthetics. In addition, this efficiency is limited because of the maximal heights laid on by the environmental and/or mechanical constraints.

In order to cope with this drawback, some people propose to replace these noise-barrier walls by plant blocks. These blocks are however essentially formed of empty space, so that, in order to be efficient against noise nuisance they should be of a large width.

Though this is possible at the edge of many major highways, this is not the case in agglomerations or their surroundings where sufficient space is not available.

Thus, plant hedges are known as described in CH 157855, BE 584804, FR 2133242 and DE 19502051.

CH 157855 describes holding means aimed at permitting to hold two live branches sufficiently close to each other so that they can fuse together while leaving them the possibility of growing and to thus be able to make a plant hedge where the plant branches intertwine.

BE 584804 describes a method for making a fruit-tree hedge comprised of grafted plants.

FR 2133242 describes a growing method consisting in grafting several plants onto each other by their top, in order to form arches, so as to be able to avoid tutors.

DE 19502051 describes a plant wall aimed at being used for delimiting residential areas, sports facilities and playgrounds, which includes two parallel vertical walls each formed of plants the branches of which are intertwined, while the space delimited by said walls is filled with an eventual organic absorbing material such as for example compost.

All the plant hedges provided in these documents use the usual knowledge of the specialist in the art and are based on the principle of assembling two subjects side by side or a fragment of a subject against another one, so that they fuse together, for example through the plate-grafting method.

This method necessary implies the weaning of two opposite portions of each subject, even at least of one of them, i.e. in order to graft two subjects onto each, one cuts off the roots of one of them and one cuts off the portion above the ground of the other one. Such a method cannot permit obtaining a continuous wall likely to form a noise-barrier wall.

### SUMMARY OF THE INVENTION

The present invention is aimed at coping with these drawbacks by providing a method for making a plant wall likely to form a noise-barrier wall.

The method for making a plant wall according to the invention is essentially characterized in that it consists in preparing rooted trees provided with one or several trunks, in planting said trees very close to each other, in guiding and maintaining, by mechanical means, said trees while they sprout in order to make them fuse together, side by side, as they grow, over almost the entire height of their trunk, in order to form, along the planting line, a juxtaposition of vertical live trunks fused to each other to form a full wall.

The method used is different from those used for grafting, the subjects keep their roots and their portion above the ground, and, through their maintaining and guiding, they are caused to grow and fuse together over almost the entire height of their trunk, in order to convert them into a large number of Siamese twin subjects.

Furthermore, in the above-mentioned documents the plants intertwine in order to form a plant hedge, which does not permit to obtain a full wall and which requires, as in DE 19502051, to use a large quantity of filling material.

According to an additional feature of the method according to the invention, one prepares the soil aimed at receiving the trees, by de-compacting it very deeply so as to promote a deep rooting.

According to another additional feature of the method according to the invention, the mechanical means consist of a trellis, and/or of rigid elements arranged transversally, made integral with the trunks.

The trellis or the rigid elements can be made out of different materials, for example of metal. They are aimed at maintaining the trunks into contact with each other, so as to suppress the friction effects between them, generated for example by the wind, and to thus accelerate the fusion or grafting process. The trellis and/or the rigid elements can be temporarily fixed or left permanently until it is enclosed by the plant material and incorporated into same.

According to another additional feature of the method according to the invention, the mechanical means consist of posts driven deep into the soil, and which the trees are made integral with.

Like for the trellis and the rigid elements, the posts permit to maintain the trunks immovable with respect to each other, and to avoid the friction movements generated for example by the wind. They can be for temporary use, during the time necessary to achieve the integral connection between the trunks themselves.

According to a variant of the method according to the invention, cut back trees are used, on which only the aligned trunks are kept, so as to form candles.

According to another variant, trees such as willows or poplars are used, the trunks of which are associated to each other by means of the so-called plate-grafting technique.

The so-called plate-grafting technique consists in planing a bark slice on the side of the trunk in the direction of the length of the latter, so as to obtain a flat portion having a width of some centimetres, according to the size of the trunk and on the whole or part of the length of the trunk, and in repeating the operation on the trunk of the other tree to be grafted, then in assembling both trunks against each other while adjusting the barks of one trunk with the barks of the adjacent trunk, and in applying the planed areas against each other, then in maintaining both trunks with a slight pressure by any mechanical maintaining means for a sufficient period, which may range from six to twelve months, in order to permit a fusion or grafting.

According to another additional feature of the method according to the invention, at the top of the trees, a special de-structuring cut of the branches is carried out, so as to be able to carry out a knotting into a bundle of the branches of a trunk with the other one, and to obtain an integral connection to each other of the tops of the trees.

According to another additional feature of the method according to the invention, the nursery process is carried out for a set of some trees, so as to obtain for each of its sets, after said trees have fused together or grafted onto each other as they grow, a root panel, the panels obtained are transplanted on the final site for receiving the wall, while juxtaposing and aligning them, and guiding them and maintaining them by mechanical means.

This variant of the method has numerous advantages. Indeed, in nurseries it is easier to control the problems of friction between the trunks, and namely to protect the plantations from the wind, so as to more quickly achieve a graft setting.

According to another additional feature of the method according to the invention, in nursery the assembling of the trees of a set of trees is carried out by means of a frame having dimensions adapted to the desired root panel to which said trees are fixed.

The frame used for the growing of the trees of a set of trees can be maintained on the latter during transplanting, in order to form the mechanical means for maintaining the panels together.

Advantageously, namely in the case of making a noise-barrier wall, plant material such as for example mosses, is implanted on the wall, so as to, on the one hand, fill some spaces that remained empty despite the growth of the trees and, on the other hand, to increase the noise-absorption capacity.

It should be noted that the use of mosses for closing the spaces can be replaced by synthetic or natural products.

The advantages and features of the method according to the invention will become clear from the following description with reference to the attached drawing, which represents one non-restrictive embodiment of same.

### BRIEF DESCRIPTION OF THE DRAWINGS

FIGS. 1a and 1b represent schematic, partial and elevational and cross-sectional views showing two steps of the method for making a plant wall according to the invention.

FIG. 2 represents a schematic, perspective and cross-sectional view of a plant wall obtained by means of the method according to the invention.

FIGS. 3a, 3b, 3c and 3d represent schematic, partial and elevational and cross-sectional views showing successive steps of a variant of the method for making a plant wall according to the invention.

FIG. 4 represents a schematic, partial cross-sectional view of a variant of a plant wall during its making with the method according to the invention.

FIG. 5 represents a schematic, elevational and cross-sectional view showing a step of the same method according to the invention.

FIG. 6 represents an elevational and cross-sectional view showing a step of variant of the same method.

### DETAILED DESCRIPTION OF THE DRAWINGS

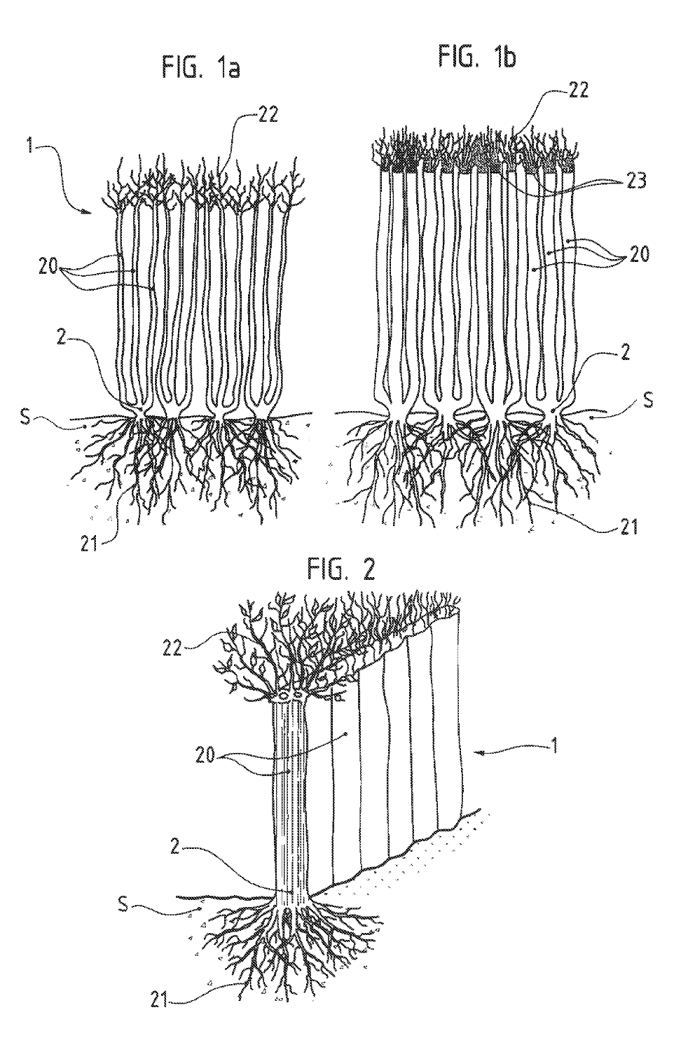

When referring to FIG. 1a, one can see a step of making a plant wall 1. According to the invention, trees 2 have been planted very close to each other, these trees 2 being cut back trees on which only the aligned trunks 20 are preserved, so as to form candles.

The soil S has previously been prepared in depth, in order to promote the expansion in depth of the roots 21 of the trees 2.

When referring to FIG. 1b, one can see that in a next step of the method according to the invention, the branches 22 of the top of the trees 2 are cut and arranged so as to permit during their growth their knotting into bundles 23.

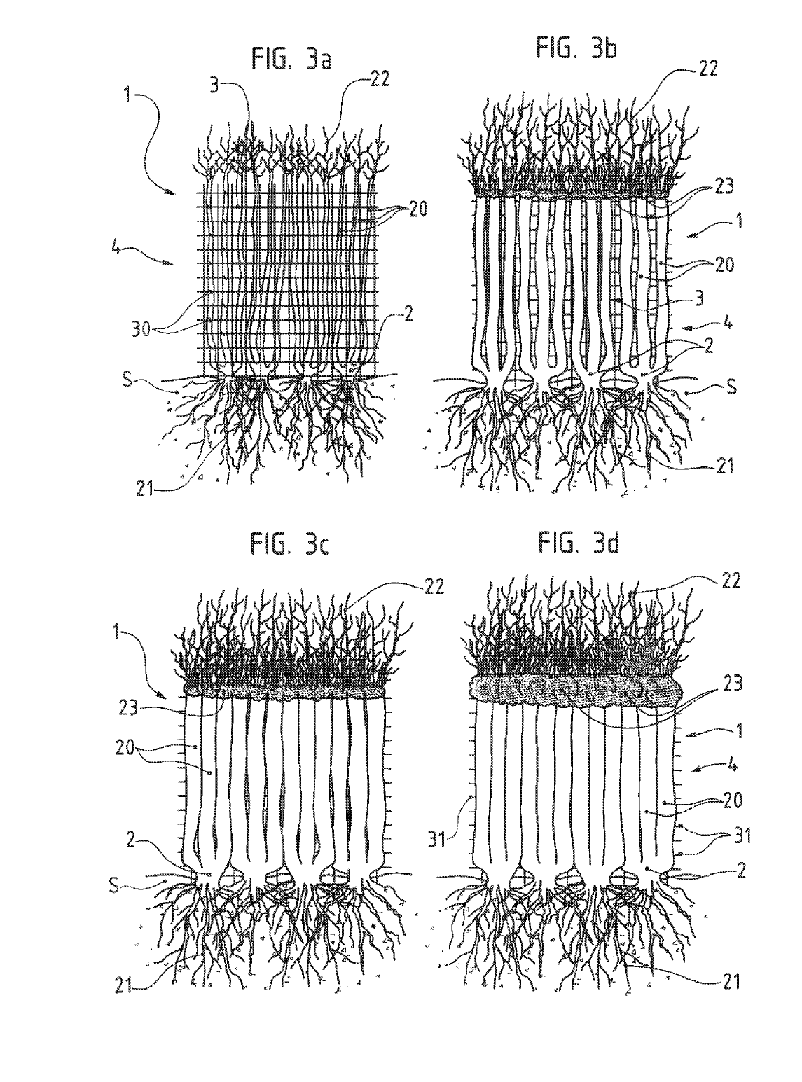

In FIG. 3, one can see a plant wall 1 according to the invention obtained by planting trees 2.

When referring now to FIGS. 3a, 3b, 3c and 3d, one can see several steps of the evolution of a plant wall 1 made according to the method object of the invention, in which mechanical guiding and maintaining means are incorporated. Thus, as can be seen in FIG. 3a, the plant wall 1 is comprised of cut back trees 2 planted side by side, and connected by means of a trellis 3 that can be made out of different materials, of metal or plastic. The trellis 3 is fixed to each of the trunks 20, for example by means of clips 30.

On the plant wall 1 of FIG. 3b is carried out the knotting into a bundle of the branches 22, while the trellis 3 begins to be absorbed by the trunks 20.

In FIGS. 3c and 3d, one can see that subsequently the trellis 3 is fully absorbed and that during their growth the trunks 20 got closer to each other, until they touched each other.

Furthermore, the method according to the invention permits to create a plant wall 1 either by installing it directly on the site to be protected and by causing it to grow or by making, according to the same method, in nursery panels of several trees aimed, after having reached at least a certain level of growth, at being transplanted on the site of creation of a wall.

The plant walls 1 as shown in FIGS. 3a, 3b, 3c and 3d are formed by bringing four trees 2 close to each other, each one comprising 3 trunks 20, which can form a panel 4 according to the invention.

It should thus be noted that the trellis 3 used for maintaining and guiding the trunks 20 of a panel 4 includes a portion 31 that laterally protrudes beyond the outermost trunks 20 of two trees 2 of a panel 4. These portions 31 of the trellis 3 are aimed, after transplanting the panels 4, at being made integral with each other and at thus uniting two abutting panels 4.

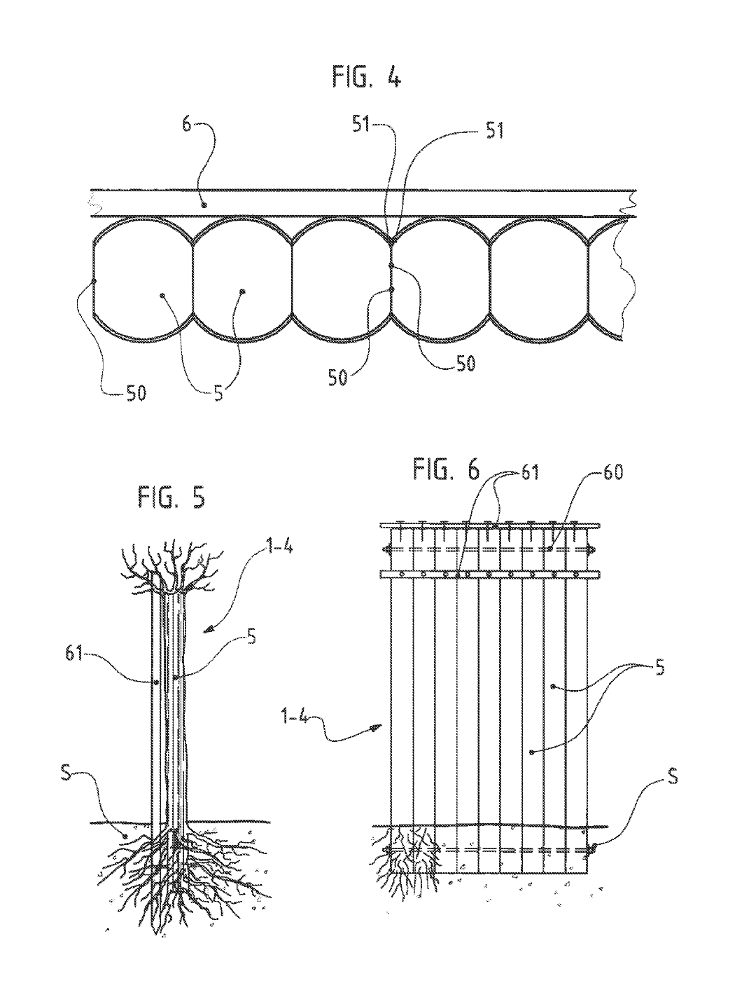

When referring now to FIGS. 4, 5 et 6, one can see a variant of the method according to the invention the implementing features of which are related in particular to the species used and to their capabilities of grafting, for example the willows.

The method consists in using willow trunks 5, in first planing them longitudinally on two sides in order to obtain two flat faces 50, then in bringing the trunks in abutment and maintaining them placed against each other, two by two, with their faces 50 against each other and in also bringing the cutting lines of the barks 51 in abutment.

In parallel, the trunks 5 are planted in the soil S, in order for them to grow roots.

This variant of the method according to the invention requires the use, on the one hand in order to permit the grafting to set, maintaining means such as bars 6 arranged transversally and nailed into the trunks 5, or threaded rods 60 passing through the diametrically trunks and, on the other hand during rooting, posts 61 planted deep into the soil S.

It should be noted that, advantageously, the flat faces 50 may not be diametrically opposite each other, which permits to create angles.

This variant of the method according to the invention can also permit to make transplantable panels in nurseries.

It should also be noted that the method according to the invention can incorporate, in addition to the operations of making a wall 1 or panels 4, operations of a more esthetical nature, but which can also lead to a reinforcement, such as for example the inclination, the bending or twisting of the trunks, or of part of them.

Irrespective of the version of the method according to the invention, it is possible to complement the growth of the trees by adding materials likely to close holes that would remain in or on the plant wall 1. The materials can be of different natures, they can be plant or synthetic materials.

Among the plant materials, mosses can be used, which, besides their capability of filling the openings, offer the advantage of being highly sound-absorbent.

Among the synthetic materials, it is possible to use products such as silicone.

It should also be noted that the choice of the species is of great importance. Besides the capabilities of some species of an easy malleability, some can be chosen for their sound-absorbing quality, in particular in the case of making a noise-barrier wall. Thus, for example, species forming most cork can preferably be chosen.

The method according to the invention permits to create a plant wall permitting a protection against either acoustic or visual nuisance, but also for impeding access, while meeting the environmental requirements.

Furthermore, a plant wall obtained with the method according to the invention can reach high heights, without requiring anchoring or concrete means, as this is currently the case for the noise-barrier walls.

1. Method for making a plant wall, said method comprising the steps of:
preparing rooted trees provided with one or several trunks;
planting said rotted trees very close to each other; and
guiding and maintaining, by mechanical means, said trees while they sprout in order to make them fuse together or graft onto each other, side by side, as they grow, over almost the entire height of their trunk, in order to form, along the planting line, a juxtaposition of vertical live trunks fused to each other to form a full wall.

2. Method for making a plant wall according to claim 1, wherein soil aimed at receiving the trees is prepared by de-compacting it very deep so as to promote a deep rooting.

3. Method for making a plant wall according to claim 1, wherein the mechanical means comprises a trellis or rigid elements arranged transversally, made integral with the trunks.

4. Method for making a plant wall according to claim 1, wherein the mechanical means comprise posts driven deep into the soil, and which the trees are made integral with.

5. Method for making a plant wall according to claim 1, wherein cut back trees are used, on which only the aligned trunks are kept, so as to form candles.

6. Method for making a plant wall according to claim 1, wherein cut back trees such as willows or poplars are used, the trunks of which are associated to each other by means of the so-called plate-grafting technique.

7. Method for making a plant wall according to claim 1, wherein at the top of the trees a special de-structuring cut of the branches is carried out, so as to be able to carry out a knotting into a bundle of the branches of a trunk with the other one, and to obtain an integral connection to each other of the tops of the trees.

8. Method for making a plant wall according to claim 1, wherein the nursery process is carried out for a set of some trees, so as to obtain for each of its sets, after said trees have fused together or grafted onto each other as they grow, a root panel, then the panels obtained are transplanted on the final site for receiving the wall, while juxtaposing and aligning them, and guiding them and maintaining them by mechanical means.

9. Method for making a plant wall according to claim 8, wherein in nursery the assembling of the trees of a set of trees is carried out by means of a frame having dimensions adapted to the desired root panel to which said trees are fixed.

10. Method for making a plant wall according to claim 1, wherein the spaces that remain between the trunks are filled with moss or another plant material that is caused to sprout, or with synthetic material that is arranged in them.
